(19) United States
(12) Patent Application Publication
(10) Pub. No.: US 2017/0027671 A1
(43) Pub. Date: Feb. 2, 2017

(54) APPARATUS AND METHOD FOR CREATING AND MANAGING TEETH MODEL

(71) Applicant: ELECTRONICS AND TELECOMMUNICATIONS RESEARCH INSTITUTE, Daejeon (KR)

(72) Inventors: Hye-Sun KIM, Daejeon (KR); Hyun KANG, Daejeon (KR); Jae-Hean KIM, Sejong (KR); Chang-Joon PARK, Daejeon (KR); Yun-Ji BAN, Daejeon (KR); Dong-Wan RYOO, Daejeon (KR); Jung-Jae YU, Daejeon (KR); Jin-Sung CHOI, Daejeon (KR)

(21) Appl. No.: 15/071,949

(22) Filed: Mar. 16, 2016

(30) Foreign Application Priority Data
Jul. 30, 2015 (KR) 10-2015-0108238

(51) Int. Cl. A61C 13/00; G06T 7/00; G06F 17/30; G06K 9/62; G06K 9/52; A61C 13/34; G06T 17/00

(52) U.S. Cl. CPC A61C 13/0004; A61C 13/34; G06T 7/0012; G06T 17/00; G06K 9/6215; G06T 7/0042; G06K 9/52; G06F 17/3028; G06T 2207/30036; G06T 2200/04

(57) ABSTRACT

An apparatus and method for managing a teeth model. The apparatus for managing a teeth model includes a database for storing a 3D intraoral structure image and a 3D teeth model image generated by scanning a healthy intraoral structure and teeth of a user; a generation unit for generating a damaged tooth model image by scanning a damaged tooth when the tooth of the user is damaged; and a modeling unit for modeling any one of a dental prosthesis and an artificial tooth by comparing the damaged tooth model image and the image stored in the database.

### CROSS REFERENCE TO RELATED APPLICATION

This application claims the benefit of Korean Patent Application No. 10-2015-0108238, filed Jul. 30, 2015, which is hereby incorporated by reference in its entirety into this application.

### BACKGROUND OF THE INVENTION

1. Technical Field

The present invention relates generally to technology for creating and managing a teeth model. More particularly, the present invention relates to technology for creating and managing a healthy teeth model for individuals to help prevent tooth loss and damage and to provide a healthy teeth model when necessary.

2. Description of the Related Art

In the event of tooth loss or tooth damage, for example, when a tooth is damaged by erosion thereof or when a tooth is lost due to external shocks, the tooth may be restored through various treatment methods, such as dental prosthesis treatment, dental implantation, and the like. Generally, such treatments are provided using a dental prosthesis or an artificial tooth that is shaped to resemble as closely as possible the original tooth of the user. To this end, a plaster teeth model or data acquired by scanning the inside of a user's mouth using a 3D scanner may be used. Because mastication or the appearance of a user can be affected by how precisely a dental prosthesis, a dental implant, or an artificial tooth is made, the experience or the ability of a dental technician who makes these items is very important.

However, when the tooth is already missing or a large part thereof has been damaged, there is no data to be referred to by a dentist or a dental technician. In this case, there is no choice but to make a dental prosthesis or an artificial tooth based on an existing general tooth model. When such a general tooth model is used, the distinct feature of the user's tooth cannot be reflected, thus there may be problems in occlusion with adjacent teeth or mastication. At present, in order to solve this problem, dental technicians have to create an artificial tooth manually. Therefore, considerable time and effort are required, and practical restoration of the tooth cannot be realized.

Korean Patent Application Publication No. 2004-0001698 discloses a technique for providing a digital tooth model using a 3D scanner. Specifically, according to the technique, after acquiring a 3D tooth model generated when a patient receives dental treatment, the acquired tooth model is used for the treatment.

However, because Korean Patent Application Publication No. 2004-0001698 uses a tooth model acquired when a patient receives dental treatment, it has a disadvantage in that restoration of a previous healthy tooth may not be realized.

Therefore, in consideration of the importance of healthy teeth and the rapid spread of dental prostheses and dental implants, there is the need for a technique for providing an image of healthy teeth and a technique for creating artificial teeth and dental prostheses that can minimize discomfort by using an image of healthy teeth.

### SUMMARY OF THE INVENTION

An object of the present invention is to restore a tooth to a healthy state in the event of tooth loss or tooth damage.

Another object of the present invention is to make an elaborate dental prosthesis.

A further object of the present invention is to store an image of healthy teeth for the future precise manufacture of dental prostheses and restoration of healthy teeth.

In order to accomplish the above object an apparatus for managing a teeth model includes a database for storing a 3D intraoral structure image and a 3D teeth model image, generated by scanning an intraoral structure and healthy teeth of a user; a generation unit for generating a damaged tooth model image by scanning a damaged tooth when the tooth of the user is damaged; and a modeling unit for comparing the damaged tooth model image with the 3D teech model image and for modeling a dental prosthesiss and an artificial tooth corresponding to the missing or damaged tooth using a result of the comparision.

The modeling unit may extract a damaged part from the 3D teeth model image by calculating a difference between the damaged tooth model image and the 3D teeth model image stored in the database and model a dental prosthesis corresponding to the damaged part.

The modeling unit may analyze the damaged tooth model image, extract an image corresponding to a totality of the damaged tooth from the 3D teeth model image if a percentage of the damaged part is equal to or greater than a specific value, and model the artificial tooth based on the extracted image.

The modeling unit may extract a position of the damaged part, extract an image corresponding to a totality of the damaged tooth from the 3D teeth model image if the position of the damaged part corresponds to a center part of the tooth, and model the artificial tooth based on the extracted image.

The apparatus for managing a teeth model may further include a treatment method guide generation unit for generating a guide to a method for treating the damaged tooth based on a result of comparing the damaged tooth model image with the image stored in the database.

The apparatus for managing a teeth model may further include a guide generation unit for generating a guide to a process for generating the artificial tooth or the dental prosthesis based on a result of comparing the damaged tooth model image with the image stored in the database.

The guide generation unit may generate the guide in a form of a video.

Images in the database may be deleted after a specific period from a date on which the images were stored.

The apparatus for managing a teeth model may transmit the 3D intraoral structure image and the 3D teeth model image corresponding to the user when receiving information corresponding to a request of the user.

Also, a method for managing a teeth model according to an embodiment of the present invention includes storing a 3D intraoral structure image and a 3D teeth model image, generated by scanning an intraoral structure and healthy teeth of a user, in a database; generating a damaged tooth model image by scanning a damaged tooth when the tooth of the user is damaged; and comparing the damaged tooth model image with the image stored in the database and modeling any one of a dental prosthesis and an artificial tooth.

Modeling the dental prosthesis and the artificial tooth may be configured to extract a damaged part from the 3D teeth model image by calculating a difference between the damaged tooth model image and the 3D teeth model image stored in the database, and to model a dental prosthesis corresponding to the damaged part.

Modeling the dental prosthesis and the artificial tooth may be configured to analyze the damaged tooth model image, to extract an image corresponding to a totality of the damaged tooth from the 3D teeth model image if a percentage of the damaged part is equal to or greater than a specific value, and to model the artificial tooth based on the extracted image.

Modeling the dental prosthesis and the artificial tooth may be configured to extract a position of the damaged part, to extract an image corresponding to a totality of the damaged tooth from the 3D teeth model image if the position of the damaged part corresponds to a center part of the tooth, and to model the artificial tooth based on the extracted image.

The method for managing a teeth model may farther include generating a guide to a method for treating the damaged tooth based on a result of corn paring the damaged tooth model image with the image stored in the database.

The method for managing a teeth model may further include generating a guide to a process for generating the artificial tooth or the dental prosthesis based on a result of comparing the damaged tooth model image with the image stored in the database.

Generating the guide may be configured to generate the guide in a form of a video.

The database may analyze a date on which each of images is stored, compare the date with a present time, and delete images if a time period during which the images have been stored exceeds a specific period.

The method for managing a teeth model may further include transmitting the 3D intraoral structure image and the 3D teeth model image corresponding to the user when receiving information corresponding to a request of the user.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating an apparatus for managing a teeth model according to an embodiment of the present invention;

FIG. 2 is a view illustrating a 3D intraoral scanner and a 3D dental scanner;

FIG. 3 is a view illustrating a 3D teeth model image generated using the 3D intraoral scanner and the 3D dental scanner, illustrated in FIG. 2;

FIG. 4 is a view illustrating a process of transmitting a 3D teeth structure model stored in a database;

FIG. 5 is a view illustrating a process of modeling a dental prosthesis in the modeling unit illustrated in FIG. 1;

FIG. 6 is a block diagram illustrating an apparatus for managing a teeth model according to another embodiment of the present invention; and

FIG. 7 is a flowchart illustrating a method for managing a teeth model according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment according to the present invention will be described in detail with reference to the accompanying drawings.

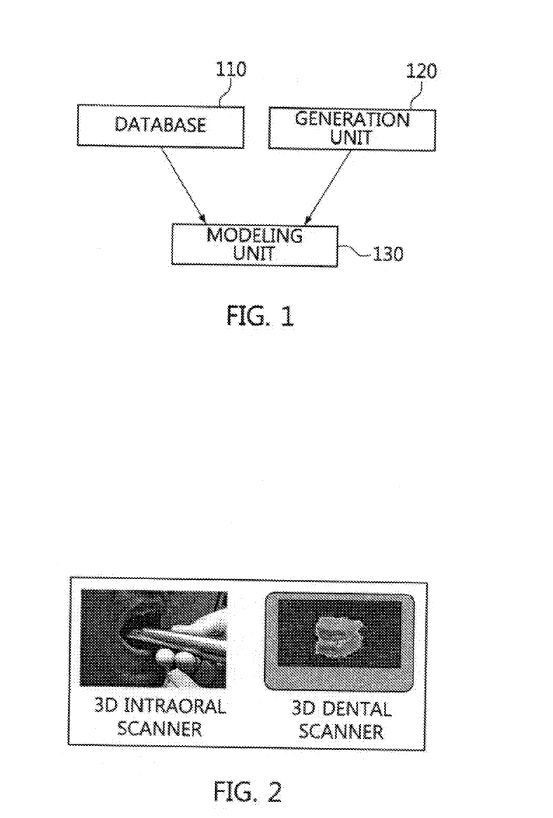

FIG. 1 is a block diagram illustrating an apparatus for managing a teeth model according to an embodiment of the present invention.

Referring to FIG. 1, the apparatus for managing a teeth model according to an embodiment of the present invention includes a database 110, a generation unit 120, and a modeling unit 130.

The database 110 stores a 3D intraoral structure image and a 3D teeth model image, generated by scanning a user's intraoral structure and healthy teeth.

Here, the 3D intraoral structure image is generated by scanning the user's intraoral structure using the 3D intraoral scanner illustrated in FIG. 2.

Also, the 3D teeth model image is generated by scanning the user's teeth using the 3D dental scanner illustrated in FIG. 2.

In this case, the image stored in the database may include at least one of an upper jaw teeth model, a lower jaw teeth model, and an upper and lower jaw teeth model of the user. The images shown in FIG, 3 may be stored in the database 110.

In response to a user's request, the 3D intraoral structure image and the 3D teeth model image, stored in the database, may be transmitted to places that need a teeth model, such as a dental clinic, a dental laboratory, a dental imaging center, a dental insurance company, and the like. For example, with reference to FIG. 4, the 3D intraoral structure image and the 3D teeth model image are transmitted to a dental clinic that provides dental treatment or a dental laboratory that makes dental prostheses or artificial teeth. Accordingly, a dentist may receive and analyze the teeth model, generated when the teeth were healthy, and may use it in order to determine a dental treatment method. Also, a dental technician may model and create a dental prosthesis or an artificial tooth using the teeth model that was generated when the teeth were healthy.

The images in the database 110 may be deleted after a certain period from the date on which the images were stored.

Here, the certain period may a period during which the user corresponding to the image uses this service, and the image may be deleted after the service expires.

When a user's tooth is damaged, the generation unit 120 generates a damaged tooth model image by scanning the damaged tooth.

The user's tooth may be damaged for various reasons. For example, a tooth may be damaged due to the user's carelessness, an accident, or the like. The damaged tooth may not recover, but the damaged part of the tooth may be filled with a dental prosthesis so as to repair the damage, or the damaged tooth may be replaced with an artificial tooth to repair the damage.

Here, in order to scan the damaged tooth, the 3D intraoral scanner and the 3D dental scanner, illustrated in FIG. 2, may be used.

The modeling unit 130 compares the damaged tooth model image and the image stored in the database and models any one of a dental prosthesis and an artificial tooth.

In this case, the modeling unit 130 calculates the difference between the 3D teeth model image stored in the database and the damaged tooth model image, generated by the generation unit 120. As the result, the damaged part may be extracted from the 3D teeth model image, and it is possible to model a dental prosthesis corresponding to the damaged part.

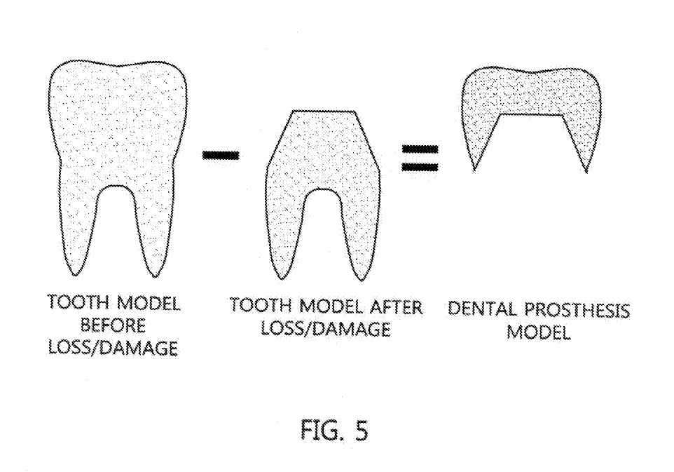

Specifically' described with reference to FIG. 5, first, a tooth model before the damage or loss is extracted from a 3D teeth model image stored in the database.

Next, a tooth model after the damage or loss is extracted from the damaged tooth model image generated by the generation unit 120.

Here, the result of calculating the difference between the tooth model before the damage or loss and the tooth model after the damage or loss becomes the tooth model for the damaged or missing tooth, and thus corresponds to a dental prosthesis. Therefore, the dental prosthesis may be modeled using the result of calculating the difference.

Also, if the percentage of the damaged part is equal to or greater than a specific value when analyzing the damaged tooth model image, the modeling unit 130 extracts the image of the entire damaged tooth from the 3D teeth model image, and may model an artificial tooth based on the extracted image.

In this case, even if the percentage of the damaged part is less than the specific value as the result of the analysis of the damaged tooth model image, when the damaged part is in the center of the tooth, the modeling unit 130 extracts the image of the entire damaged tooth from the 3D teeth model image, and may model an artificial tooth based on the extracted image. For example, when only the center part of the tooth is damaged, a dental prosthesis may not adhere to the damaged part due to the position thereof. In such cases, it is necessary to put in an artificial tooth. Consequently, depending on the position of the damaged part, even if the percentage thereof is less than the specific value, an artificial tooth may be modeled.

Although not illustrated in FIG. 1, an apparatus for managing a teeth model according to an embodiment of the present invention may further include a treatment method guide generation unit for generating a guide to a method for treating the damaged tooth based on the result of comparing the damaged tooth model image with the image stored in the database 110.

Also, the apparatus for managing a teeth model according to an embodiment of the present invention may further include a guide generation unit for generating a guide to a process of making an artificial tooth or a dental prosthesis based on the result of comparing the damaged tooth model image with the image stored in the database.

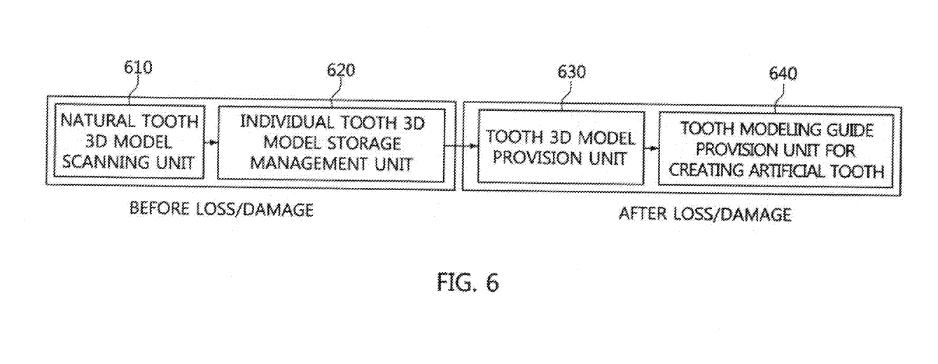

FIG. 6 is a block diagram illustrating an apparatus for managing a teeth model according to another embodiment of the present invention.

Referring to FIG. 6, the apparatus for managing a teeth model includes a natural tooth 3D model scanning unit 610, an individual tooth 3D model storage management unit 620, a tooth 3D model provision unit 630, and a tooth modeling guide provision unit 640 for creating an artificial tooth.

The natural tooth 3D model scanning unit 610 scans the inside of a user's mouth using the 3D intraoral scanner and the 3D dental scanner, illustrated in FIG. 2, and then generates a 3D model of the teeth and gums.

The individual tooth 3D model storage management unit 620 stores a 3D intraoral structure image and a 3D teeth model image in the database 110, as illustrated in FIG. 1.

The tooth 3D model provision unit 630 provides the 3D intraoral structure image and the 3D teeth model image, stored in the database 110, to a dental care service provider that includes a dental clinic, a dental laboratory, a dental imaging center, a dental insurance company, and the like, which are provided with the above-mentioned service.

Here, the images may be stored in the database 110 for a desired period, depending on the request of the user corresponding to the image.

The database 110 may store and manage the images for each user.

The tooth modeling guide provision unit 640 for creating an artificial tooth may provide a guide to a process of creating an artificial tooth corresponding to the damaged tooth by comparing the damaged tooth model image, generated by the generation unit 120 illustrated in FIG. 1, with the image stored in the database 110.

Here, the natural tooth 3D model scanning unit 610 and the individual tooth 3D model storage management unit 620 may be provided before a tooth is damaged, that is, when teeth are healthy. The tooth 3D model provision unit 630 and the tooth modeling guide provision unit 640 for creating an artificial tooth may be provided when a tooth is damaged.

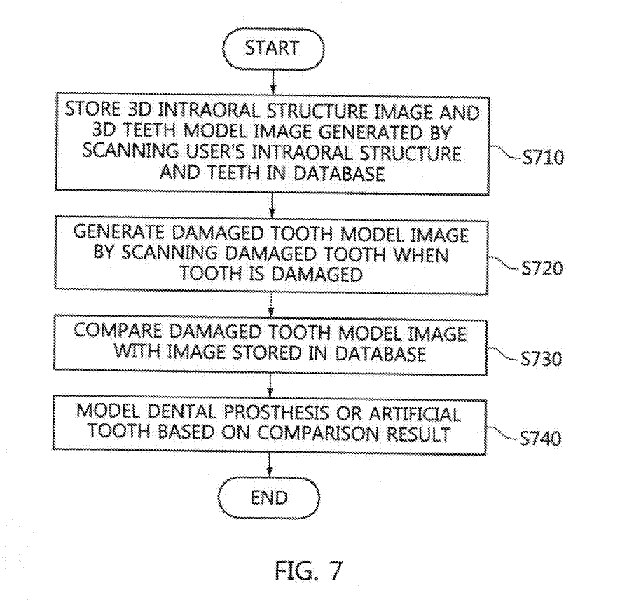

FIG. 7 is a flowchart illustrating a method for managing a teeth model according to an embodiment of the present invention.

Referring to FIG. 7, first, in the method for managing a teeth model according to an embodiment of the present invention, a 3D intraoral structure image and a 313 teeth model image, generated by scanning an intraoral structure and the teeth of a user, are stored in a database at step S710.

Here, the user's intraoral structure is scanned using the 3D intraoral scanner illustrated in FIG. 2, and then the 3D intraoral structure image is generated.

Also, the user's teeth are scanned using the 3D dental scanner illustrated in FIG. 2, and then the 3D teeth model image is generated.

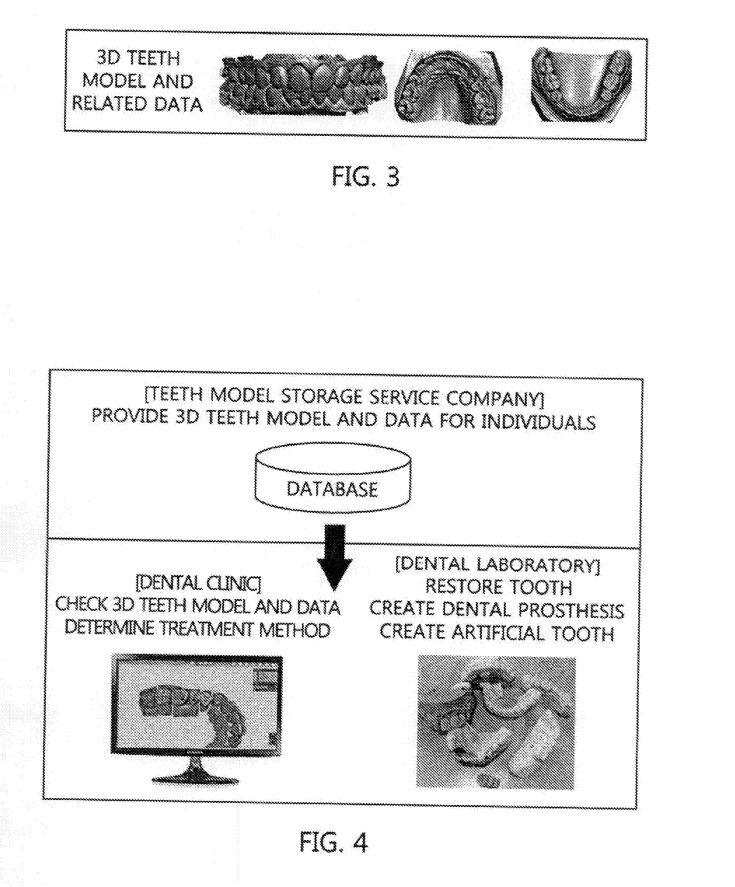

In this case, the image stored in the database may include at least one of an upper jaw teeth model, a lower jaw teeth model, and an upper and lower jaw teeth model of the user. The images shown in FIG. 3 may be stored in the database 110.

In response to a user's request, the 3D intraoral structure image and the 3D teeth model image, stored in the database, may be transmitted to places that need a teeth model, such as a dental clinic, a dental laboratory, a dental imaging center, a dental insurance company, and the like. For example, with reference to FIG. 4, the 3D intraoral structure image and the 3D teeth model image are transmitted to a dental clinic that provides dental treatment or a dental laboratory that makes dental prostheses or artificial teeth. Accordingly, a dentist may receive and analyze the teeth model, which was generated when the teeth were healthy, and may use it in order to determine a dental treatment method. Also, a dental technician may model and make a dental prosthesis or an artificial tooth using the teeth model generated when the teeth were healthy.

The images in the database 110 may be deleted after a certain period from the date on which the images were stored.

Here, the certain period may a period during which the user corresponding to the image uses this service, and the image may be deleted after the service expires.

Also, when a user's tooth is damaged, a damaged tooth model image is generated by scanning the damaged tooth at step S720.

The user's tooth may be damaged due to various reasons. For example, a tooth may be damaged due to user's carelessness, an accident, or the like. The damaged tooth may not recover, but the damaged part of the tooth may be filled with a dental prosthesis so as to repair the damage, or the damaged tooth may be replaced with an artificial tooth to repair the damage.

Here, in order to scan the damaged tooth, the 3D intraoral scanner and the 3D dental scanner illustrated in FIG. 2 may be used.

Also, the modeling unit 130 compares the damaged tooth model image with the image stored in the database at step S730, and may model any one of a dental prosthesis and an artificial tooth based on the comparison result at step S740.

In this case, the modeling unit 130 calculates the difference between the 3D teeth model image stored in the database and the damaged tooth model image, generated by the generation unit 120. As the result, the damaged part may be extracted from the 3D teeth model image, and it is possible to model a dental prosthesis corresponding to the damaged part.

Specifically described with reference to FIG. 5, first, a tooth model before the damage or loss is extracted from a 3D teeth model image stored in the database.

Next, a tooth model after the damage or loss is extracted from the damaged tooth model image generated by the generation unit 120.

Here, a result of the difference between the tooth model before the damage or loss and the tooth model after the damage or loss becomes a tooth model for the damaged or missing tooth, and thus corresponds to a dental prosthesis. Therefore, the dental prosthesis may be modeled using the result of calculating the difference.

Also, if the percentage of the damaged part is found to be equal to or greater than a specific value when analyzing the damaged tooth model image, the modeling unit 130 extracts the image of the entire damaged tooth from the 3D teeth model image and models an artificial tooth based on the extracted image.

In this case, even if the percentage of the damaged part is less than the specific value as the result of the analysis of the damaged tooth model image, when the damaged part is in the center of the tooth, the modeling unit 130 extracts the image of the entire damaged tooth from the 3D teeth model image, and may model an artificial tooth based on the extracted image. For example, when only the center part of the tooth is damaged, a dental prosthesis may not be adhered to the damaged part due to the position thereof. Therefore, it is necessary to put in an artificial tooth. Consequently, depending on the position of the damaged part, even if the percentage thereof is less than the specific value, an artificial tooth may be modeled.

The present invention may restore a tooth to a healthy state using a teeth model, generated by previously scanning healthy teeth, in the event of dental loss or damage.

Also, the present invention enables the precise manufacture of a dental prosthesis using the result of comparison of an image of a damaged tooth with an image of a healthy tooth.

Also, the present invention may make an elaborate dental prosthesis and an artificial tooth that has the same shape as a healthy tooth, thus minimizing user's inconvenience.

As described above, the apparatus and method for managing a teeth model according to the present invention are not limitedly applied to the configurations and operations of the above-described embodiments, but all or some of the embodiments may be selectively combined and configured so that the embodiments may be modified in various ways.

What is claimed is:

1. An apparatus for managing a teeth model, comprising:
a database for storing a 3D intraoral structure image and a 3D teeth model image, generated by scanning an intraoral structure and healthy teeth of a user;
a generation unit for generating a damaged tooth model image by scanning a missing or damaged tooth when the tooth of the user is missing or damaged; and
a modeling unit for comparing the damaged tooth model image with the 3D teeth model image and for modeling a dental prosthesis and an artificial tooth corresponding to the missing or damaged tooth using a result of the comparison.

2. The apparatus of claim 1, wherein the modeling unit extracts a damaged part from the 3D teeth model image by calculating a difference between the damaged tooth model image and the 3D teeth model image stored in the database and models a dental prosthesis corresponding to the damaged part.

3. The apparatus of claim 2, wherein the modeling unit
analyzes the damaged tooth model image,
extracts an image corresponding to a totality of the damaged tooth from the 3D teeth model image if a percentage of the damaged part is equal to or greater than a specific value, and
models the artificial tooth based on the extracted image.

4. The apparatus of claim 2, wherein the modeling unit
extracts a position of the damaged part,
extracts an image corresponding to a totality of the damaged tooth from the 3D teeth model image if the position of the damaged part corresponds to a center part of the tooth, and
models the artificial tooth based on the extracted image.

5. The apparatus of claim 4, further comprising,
a treatment method guide generation unit for generating a guide to a method for treating the damaged tooth based on a result of comparing the damaged tooth model image with the image stored in the database.

6. The apparatus of claim 4, further comprising,
a guide generation unit for generating a guide to a process for generating the artificial tooth or the dental prosthesis based on a result of comparing the damaged tooth model image with the image stored in the database.

7. The apparatus of claim 6, wherein the guide generation unit generates the guide in a form of a video.

8. The apparatus of claim 1, wherein the database analyzes a date on which each of images is stored, compares the date with a present time, and deletes images if a time period during which the images have been stored exceeds a specific period.

9. The apparatus of claim 1, wherein the apparatus for managing the teeth model transmits the 3D intraoral structure image and the 3D teeth model image corresponding to the user when receiving information corresponding to a request of the user.

10. A method for managing a teeth model, comprising:
storing a 3D intraoral structure image and a 3D teeth model image, generated by scanning an intraoral structure and healthy teeth of a user, in a database;
generating a damaged tooth model image by scanning a damaged tooth when the tooth of the user is damaged; and
comparing the damaged tooth model image with the image stored in the database and modeling any one of a dental prosthesis and an artificial tooth.

11. The method of claim 10, wherein modeling the dental prosthesis and the artificial tooth is configured to:
extract a damaged part from the 3D teeth model image by calculating a difference between the damaged tooth model image and the 3D teeth model image stored in the database; and
model a dental prosthesis corresponding to the damaged part.

12. The method of claim 11, wherein modeling the dental prosthesis and the artificial tooth is configured to:
analyze the damaged tooth model image;
extract an image corresponding to a totality of the damaged tooth from the 3D teeth model image if a percentage of the damaged part is equal to or greater than a specific value; and
model the artificial tooth based on the extracted image.

13. The method of claim 11, wherein modeling the dental prosthesis and the artificial tooth is configured to:
extract a position of the damaged part;
extract an image corresponding to a totality of the damaged tooth from the 3D teeth model image if the position of the damaged part corresponds to a center part of the tooth; and
model the artificial tooth based on the extracted image.

14. The method of claim 13, further comprising, generating a guide to a method for treating the damaged tooth based on a result of comparing the damaged tooth model image with the image stored in the database.

15. The method of claim 13, further comprising,
generating a guide to a process for generating the artificial tooth or the dental prosthesis based on a result of comparing the damaged tooth model image with the image stored in the database.

16. The method of claim 15, wherein generating the guide is configured to generate the guide in a form of a video.

17. The method of claim 10, wherein the database analyzes a date on which each of images is stored, compares the date with a present time, and deletes images if a time period during which the images have been stored exceeds a specific period.

18. The method of claim 10, further comprising transmitting the 3D intraoral structure image and the 3D teeth model image corresponding to the user when receiving information corresponding to a request of the user.
